(19) United States
(12) Patent Application Publication
(10) Pub. No.: US 2003/0003271 A1
(43) Pub. Date: Jan. 2, 2003

(54) Concrete and plastic construction panel

(76) Inventors: Vladimir M. Bykov, Arvada, CO (US); Ivan V. Sitnikov, Moscow (RU)

Correspondence Address: ANCEL W. LEWIS, JR., 425 WEST MULBERRY, SUITE 101, FORT COLLINS, CO, 80521, US

(21) Appl. No.: 09/895,131

(22) Filed: Jul. 2, 2001

(51) Int. Cl. B32B 3/10; B32B 3/12

(52) U.S. Cl. 428/139; 428/116

(57) ABSTRACT

A composite panel includes a support layer and a facing layer. The support layer has an outer surface and cavities that open through the outer surface. The cavities enlarge inward from the outer surface to form overhanging edges. The facing layer is a cement mixture that flows around the overhanging edges to overlap the support layer so that the support layer and facing layer are mechanically interlocked.

### TECHNICAL FIELD

The present invention relates to building construction facing materials and more particularly to a concrete and plastic construction panel.

### BACKGROUND ART

Concrete is a good building material, being long-lasting, moldable, water proof, fire proof, termite proof and vermin proof, and having high compressive strength. Concrete has, however, a high weight factor and relatively low tensile strength. Solid concrete panels are generally too heavy for many building panel applications, as for example, counter tops, shower enclosures, exterior facing panels, window sills and table tops.

Composite panels, having a facing layer of concrete and a support layer made of another material, can be lighter, cost less than a solid concrete panel, have better thermal and sound insulating properties, and possess all of the advantages of concrete and the support layer material. Prior known composite panels have a front facing layer of concrete, and a support layer that is adhesively attached to the facing layer after the facing layer has hardened. The adhesive adds to the cost of the panel, and the separate curing times for the concrete and the adhesive add to the manufacturing time of the panels.

Composite panels having a front facing layer of concrete, and a support layer that is adhesively attached to the facing layer do not have mechanical attachment between the facing layer and the support layer. Differential thermal expansion and contraction can degrade the adhesive bond between the layers and thereby reduce the reliability of these composite panels. U.S. Pat. No. Re. 20,607 to Tomec discloses a composite panel with a multilayer base member and a surface layer of a flowable material such as cement. The base member is adhesively bonded or stapled together and has an outer layer with apertures, an intermediate layer with apertures that are offset or larger than the apertures in the outer layer, and a solid inner layer. The material of the surface layer flows around the apertures in the outer layer of the base member to interlock with the outer layer. The attachment between the layers of the base member does not interlock.

### DISCLOSURE OF THE INVENTION

A composite panel having a concrete or cement mixture facing layer and a plastic support layer is disclosed. The support layer includes a planar outer surface, a spaced inner surface and a plurality of spaced cavities opening through the outer surface. The cavities enlarge from the outer surface into the support layer so that an overhanging edge portion is formed between each cavity and the outer surface. The facing layer is formed on the first surface and extends into the cavities. The facing layer and the overhanging edge portions of the support layer overlap and interlock to provide a durable mechanical attachment of the facing layer to the support layer.

### BRIEF DESCRIPTION OF THE DRAWINGS

Details of this invention are described in connection with the accompanying drawings that bear similar reference numerals in which:

FIG. 1 is a perspective view, partially cut away, of a counter top embodying features of the present invention.

FIG. 2 is sectional view along line 2-2 of FIG. 1.

FIG. 3 is an enlarged partial view of FIG. 2.

FIG. 4 is an enlarged partial sectional view of a first alternative panel embodying features of the present invention.

FIG. 5 is an enlarged partial sectional view of a second alternative panel embodying features of the present invention.

### DETAILED DESCRIPTION OF THE INVENTION

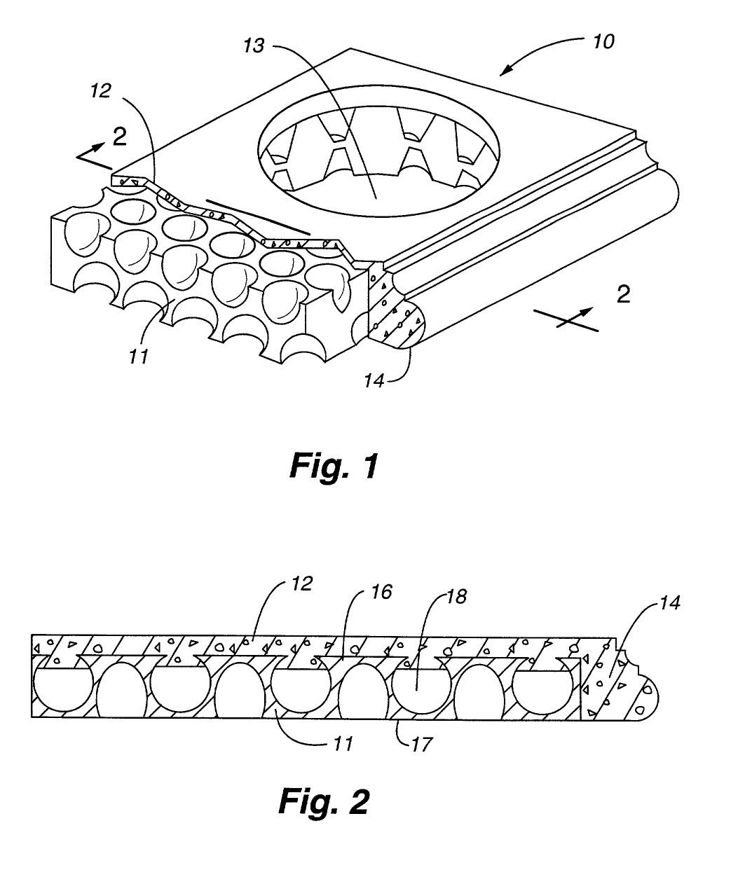

Referring now to FIGS. 1, 2 and 3, a composite panel 10 embodying features of the present invention is shown, including a support layer 11 and a facing layer 12. In the illustrated embodiment the panel 10 is shown in FIG. 1 by way of example, and not as a limitation, as a countertop that includes a sink aperture 13 for receiving a sink and a formed front side 14.

The support layer 11 is a rigid, one piece layer having a generally planar outer surface 16 and a spaced inner surface 17. The support layer 11 is a honeycomb structure including a plurality of spaced cavities 18 in the form of outer depressions 19 that open through openings 20 in the outer surface 16. Preferably the cavities are uniformly spaced to form a uniform pattern in the support layer 11. Each outer depression 19 is defined by a outer depression surface 21 that connects to the outer surface 16 at the openings 20. The outer depressions 19 widen or enlarge from the openings 20 into the support layer 11 to form overhanging edge portions 22.

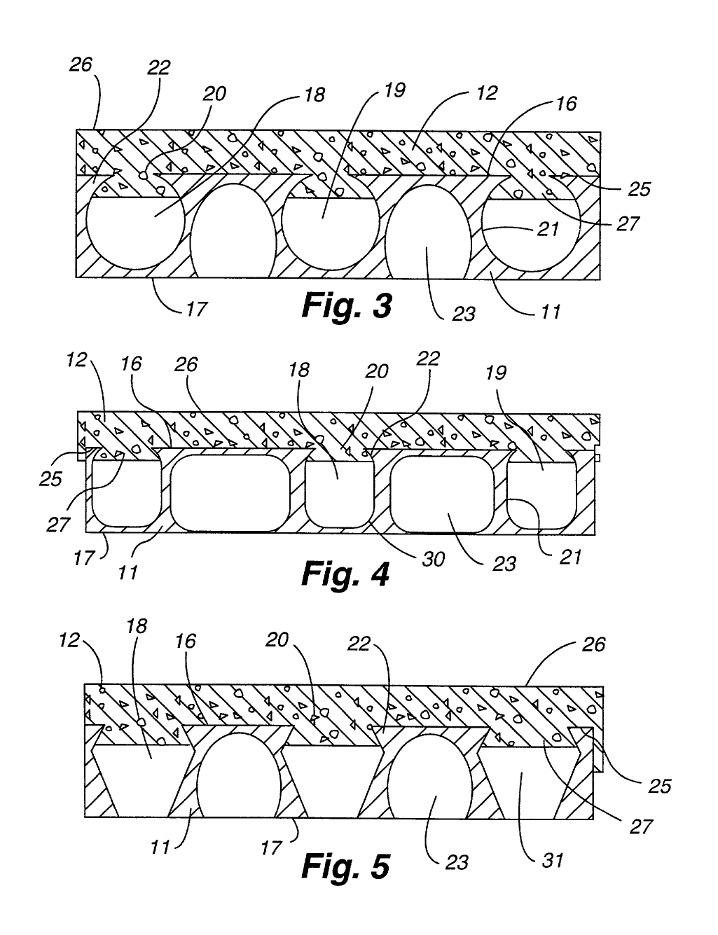

In the illustrated embodiment, as shown in FIGS. 2 and 3, the outer depressions 19 have the shape of a truncated sphere greater than a hemisphere so that the outer depression surfaces 21 connect along the openings 20 to the outer surface 16 at an acute angle. Other shapes for the outer depressions 19, such as ellipsoid or ovoid, may be used and the outer depression surfaces 21 may connect to the outer surface 16 with a straight or curved surface between, as long as an overhanging edge portion 22 is formed around a portion on the openings 20. A plurality of spaced inner depressions 23 extend into the support layer 11 closely interspersed or staggered between the outer depressions 18 and open through the inner surface 17. The inner depressions 23 preferably also have overhanging edge portions 22 connecting to the inner surface 17. The closely staggered outer depressions 19 and inner depressions 23 shown each extend through most of the support layer 11 from opposite sides and significantly reduce the weight of the support layer 11.

The facing layer 12 is formed on the outer surface 16 of the support layer 11, and has an inner face 25 on the outer surface 16 of the support layer 11 and a spaced, oppositely facing outer face 26. The facing layer 12 is formed with extending portions 27 that extend from the inner face 25 through the openings 20 and into the outer depressions 19 of the support layer 11. The extending portions 27 form around and overlap the overhanging edge portions 22 of the support layer 11 to mechanically interlock and mechanically attach or affix the facing layer 12 with the support layer 11 to form a rigid, bonded, integral, unitary panel body without requiring an adhesive. The extending portions 27 extend into the outer depressions 19 preferably only a small portion of the depth of the outer depressions 19.

FIG. 4 shows one alternative configuration for the outer depressions 19 and the inner depressions 23 of the support layer, with the outer depressions 19 and the inner depressions 23 each having a generally rectilinear polygonal shape with curved corners 30. The outer depressions 19 and the inner depressions 23 do not need to be of the same shape and other shapes may be used for either the outer depressions 19 or the inner depressions 23 as long as the overhanging edge portions 22 are formed between the outer surface 16 of the support layer 11 and the outer depressions 19. As shown is FIG. 5, the spaced cavities 18 may alternatively be in the form of apertures 31 that extend through the support layer 11 from the outer surface 16 to the inner surface 17. The apertures 31 enlarge into the support layer 11 from the outer surface 16 to form overhanging edge portions 22. The illustrated apertures 31 have a cross sectional shape, in a plane perpendicular to the outer surface 16, of a hexagon with openings 20 in the outer surface 16 and the inner surface 17 forming opposing sides, and the hexagon sides connected to the openings 20 diverging therefrom.

The support layer 11 is preferably of a thermoplastic material that is lightweight as compared to concrete and is rigid. By way of example, and not as a limitation, the cavities 18 in the form of the outer depressions 19 or the apertures 31, and inner depressions 23 can be formed in a thermoplastic material by either heating the material to near the melting temperature and directing pressurized gas into the material at selected locations on the outer surface 16 and the inner surface 17, or by directing pressurized gas that is heated above the softening temperature of the material into the material at selected locations. The cavities 18 in the form of the outer depressions 19 or the apertures 31, and inner depressions 23 may have any cross sectional shape in any plane parallel to the outer surface 16, but are most easily formed with a round or oval shape with the above methods.

The facing layer 12 is made of a cement mixture. Preferably the cement mixture includes a plasticizer. The facing layer 12 is formed on the support layer 11 by first pouring the cement mixture of the facing layer 12 into a mold and then placing the support layer 11 into the cement mixture, with the outer surface 16 of the support layer 11 facing towards the cement mixture, while the cement mixture is liquid. The cement mixture flows into the cavities 18 and around the overhanging edge portions 22. The air trapped in the outer depressions 19, in the support layers shown in FIGS. 3 and 4, limits the amount of cement mixture that enters the outer depressions 19 so that the cavities 18 are only partially filled. Preferably the support layer 11 shown in FIG. 5 with the apertures 31 is placed a limited distance into the cement mixture so that the cavities 18 are only partially filled.

The mold may be designed and the cement mixture may be mixed so that the outer face 26 of the facing layer 12 simulates stone, tile or other materials. Preferably the outer face 26 simulates decorative stone with a polished surface finish. As shown in FIG. 1 the sides 14 of the panel 10 may be formed into any desired shape. The facing layer 12 is preferably at least 3 mm thick, excluding the extending portions 27. The support layer 11 is preferably at least three times the thickness of the facing layer 12 excluding the extending portions 27.

The composite panel 10 of the present invention is suitable, by way of example, and not as a limitation, for use in counter tops, table tops, shower enclosures, window sills and exterior facing panels. The interlocking of the overhanging edge portions 22 of the support layer 11 and the extending portions 27 of the facing layer 12 assures a reliable connection between all of the layers of the panel 10, even where the panel 10 is exposed to high temperature gradients. The inner depressions 23 provide for reliable attachment of the panel 10 to a wall. The honeycomb plastic support layer 11 provides a panel 10 with significantly higher tensile strength than a solid concrete panel. The cavities 18 and inner depressions 23 together reduce the cross sectional area, in any plane parallel to the outer surface 16, of the support layer 11. The reduced cross sectional area reduces heat and sound transfer, improving the thermal and sound insulating properties of the panel 10. The partial filling of the cavities in combination with the reduced cross sectional significantly reduces the weight of the panel 10 relative to a solid concrete panel.

Although the present invention has been described with a certain degree of particularity, it is understood that the present disclosure has been made by way of example and that changes in details of structure may be made without departing from the spirit thereof.

What is claimed is:

1. A composite panel comprising:
a support layer having an outer surface, said support layer having a plurality of spaced cavities that open through said outer surface, each cavity enlarging in a direction extending into said support layer away from said outer surface to form an overhanging edge portion, and
a facing layer formed on said outer surface having a plurality of extending portions that extend into said cavities and enlarge to overlap said overhanging edge portions so that said support layer and said facing layer interlock and are rigidly mechanically attached to form a panel body.

2. The panel as set forth in claim 1 wherein said cavities are outer depressions in said outer surface.

3. The panel as set forth in claim 2 wherein said support layer includes an inner surface spaced from said outer surface and a plurality of inner depressions that open into said inner surface.

4. The panel as set forth in claim 3 wherein said outer depressions are in a uniform pattern and said inner depressions are in a uniform pattern staggered between said outer depressions.

5. The panel as set forth in claim 1 wherein said support layer includes an inner surface spaced from said outer surface and said cavities are apertures extending through said support layer from said outer surface to said inner surface.

6. The panel as set forth in claim 5 wherein said support surface includes a plurality of inner depressions that open into said inner surface and staggered between said apertures.

7. The panel as set forth in claim 1 wherein said support layer is a thermoplastic material.

8. The panel as set forth in claim 1 wherein said facing layer excluding said extending portions has a first thickness and said support layer has a second thickness that is at least three times said first thickness.

9. The panel as set forth in claim 1 wherein each said cavity enlarges along a straight line.

10. The panel as set forth in claim 1 wherein each said cavity enlarges along a curve.

11. The panel as set forth in claim 1 wherein said cavities are spherical.

12. The panel as set forth in claim 1 wherein said cavities are ovoid.

13. The panel as set forth in claim 1 wherein said cavities are ellipsoid.

14. The panel as set forth in claim 1 wherein said cavities are rectilinear polygonal.

15. The panel as set forth in claim 1 wherein said support layer is a honeycomb structure.

16. The panel as set forth in claim 1 wherein said facing layer is made of a cement mixture.

17. The panel as set forth in claim 1 wherein said facing layer has a selected exterior pattern and texture.

18. A composite panel comprising:
a rigid, one piece, lightweight, honeycomb support layer having an outer surface, said support layer having a plurality of spaced cavities that open through said outer surface, each cavity enlarging in a direction extending into said support layer away from said outer surface to form an overhanging edge portion, and
a rigid, one piece facing layer formed on said outer surface having a plurality of extending portions that extend into and partially fill said cavities and enlarge to overlap said overhanging edge portions so that said support layer and said facing layer interlock and are rigidly mechanically attached to form a rigid, unitary, bonded panel body.

19. A composite panel comprising:
a rigid, lightweight, one piece support layer of thermoplastic honeycomb material having a planar outer surface and a spaced inner surface, said support layer having a plurality of uniformly spaced outer depressions that open through said outer surface, each outer depression enlarging in a direction extending into said support layer away from said outer surface to form an overhanging edge portion, said support layer having a plurality of spaced inner depressions, staggered between said outer depressions, that open through said inner surface, and
a rigid, one piece facing layer of a cement mixture material, formed on said outer surface having extending portions formed around said overhanging edge portions, said extending portions extending into and partially filling said outer depressions and enlarging to overlap said overhanging edge portions to interlock said support layer and said facing layer and to rigidly mechanically affix said facing layer to said support layer to form a bonded panel body without requiring an adhesive.
